(19) United States
(12) Patent Application Publication
(10) Pub. No.: US 2013/0106828 A1
(43) Pub. Date: May 2, 2013

(54) Pixel Circuit, Organic Light Emitting Display Device Having the Same, and Method of Driving an Organic Light Emitting Display Device

(71) Applicant: Tae-Jin Kim, Yongin-City (KR)

(72) Inventor: Tae-Jin Kim, Yongin-City (KR)

(73) Assignee: SAMSUNG MOBILE DISPLAY CO., LTD., Yongin-City (KR)

(21) Appl. No.: 13/492,432

(22) Filed: Jun. 8, 2012

(30) Foreign Application Priority Data
Oct. 27, 2011 (KR) 10-2011-0110291

(51) Int. Cl. G09G 3/32; G06F 3/038

(52) U.S. Cl. 345/212; 345/82

(57) ABSTRACT

A pixel circuit may include a pixel unit coupled to a crossing point of a data-line and a scan-line, the pixel unit receiving a first power source voltage and a second power source voltage that are DC power source voltages, an organic light emitting diode coupled to the pixel unit, and a light emitting control transistor coupled between the pixel unit and the organic light emitting diode. Here, the light emitting control transistor may periodically turn on and off in response to a light emitting control signal having a logic high level and a logic low level in a frame, and the light emitting control signal may be simultaneously provided to a plurality of light emitting control transistors in a display panel.

### CLAIM OF PRIORITY

This application makes reference to, incorporates the same herein, and claims all benefits accruing under 35 U.S.C. §119 from an application earlier filed in the Korean Intellectual Property Office on the 27 Oct. 2011 and there duly assigned Serial No. 10-2011-0110291.

### BACKGROUND OF THE INVENTION

1. Field of the Invention

Exemplary embodiments relate generally to an organic light emitting display device. More particularly, embodiments of the inventive concept relate to an organic light emitting display device performing a simultaneous emission with active voltage (SEAV) operation using a direct-current (DC) power source voltage.

2. Description of the Related Art

An organic light emitting display (OLED) device includes a plurality of scan-lines, a plurality of data-lines, and a plurality of pixels. Here, the pixels may be arranged in a matrix form at crossing points of the scan-lines and the data-lines. According to a sequential emission technique among many techniques for driving an OLED device, the scan-lines may sequentially scan data as scan signals are sequentially applied into the scan-lines, and then OLED elements of the scan-lines may sequentially emit light when emission signals are sequentially applied into the scan-lines.

However, a crosstalk that results in dizziness may be caused when 3D (i.e., stereoscopic) images are displayed by the sequential emission technique. Therefore, a simultaneous emission with active voltage (SEAV) technique that is optimized for displaying 3D images is widely used. In conventional SEAV techniques, however, a power supply voltage is changed simultaneously, so that the conventional SEAV techniques may need additional circuit components for simultaneously changing the power supply voltage, and may consume a large amount of power due to the power supply voltage changes.

### SUMMARY OF THE INVENTION

Some exemplary embodiments provide a pixel circuit capable of controlling a direct-current (DC) power source voltage using a light emitting control transistor.

Some exemplary embodiments provide an organic light emitting display device capable of performing a simultaneous emission with active voltage (SEAV) operation using a DC power source voltage, and capable of simultaneously compensating threshold voltages of driving transistors in pixels.

Some exemplary embodiments provide a method of driving an organic light emitting display device that performs a SEAV operation using a DC power source voltage.

According to some exemplary embodiments, a pixel circuit may include a pixel unit that is coupled to a crossing point of a data-line and a scan-line, and that receives a first power source voltage and a second power source voltage that are direct-current (DC) power source voltages, an organic light emitting diode coupled to the pixel unit, and a light emitting control transistor coupled between the pixel unit and the organic light emitting diode. Here, the light emitting control transistor periodically may turn on and off in response to a light emitting control signal having a logic high level and a logic low level in a frame, and the light emitting control signal may be simultaneously provided to a plurality of light emitting control transistors in a display panel.

In an exemplary embodiment, the pixel unit may include a driving transistor having a first electrode that receives the first power source voltage and a second electrode that is coupled to the organic light emitting diode, a first transistor that is coupled between the data-line and a gate electrode of the driving transistor, and that supplies a data signal to the gate electrode of the driving transistor in response to a scan signal, a second transistor coupled between the second electrode of the driving transistor and the gate electrode of the driving transistor, a first capacitor coupled between the first electrode of the driving transistor and the gate electrode of the driving transistor, and a second capacitor coupled between the first capacitor and the gate electrode of the driving transistor.

In exemplary embodiments, the light emitting control transistor, the driving transistor, the first transistor, and the second transistor may be p-channel metal oxide semiconductor (PMOS) transistors.

In exemplary embodiments, the second transistor may apply a threshold voltage of the driving transistor to the second capacitor by diode-coupling the driving transistor in response to a threshold voltage compensation signal.

In exemplary embodiments, the light emitting control transistor may be coupled between the second electrode of the driving transistor and the organic light emitting diode.

In exemplary embodiments, the light emitting control transistor may periodically couple the first power source voltage to the organic light emitting diode in response to the light emitting control signal.

In exemplary embodiments, a reference voltage and a data voltage may be alternately stored in the first capacitor as a reference signal, and the data signal may be alternately applied through the data-line. Here, the reference voltage may correspond to the reference signal, and the data voltage may correspond to the data signal.

In exemplary embodiments, a data voltage of a previous frame stored in the first capacitor may be changed into the reference voltage, and a voltage of the gate electrode of the driving transistor may be changed into a voltage corresponding to a difference between the first power source voltage and the threshold voltage of the driving transistor when the reference signal is applied.

According to some exemplary embodiments, an organic light emitting display device may include a display panel having a plurality of pixels that receives a first power source voltage and a second power source voltage that are direct-current (DC) power source voltages, a scan driving unit that sequentially supplies a scan signal to the pixels through a plurality of scan-lines, a data driving unit that supplies a data signal to the pixels through a plurality of data-lines based on the scan signal, a compensation control unit that simultaneously supplies a threshold voltage compensation signal to the pixels, and a light emitting control unit that simultaneously supplies a light emitting control signal to the pixels. Here, each of the pixels may include an organic light emitting diode, a driving transistor having a first electrode that receives the first power source voltage and a second electrode that is coupled to the organic light emitting diode, a first transistor that is coupled between the data-line and the gate electrode of the driving transistor, and that supplies the data signal to the gate electrode of the driving transistor in response to the scan signal, a second transistor that is coupled between the second electrode of the driving transistor and the gate electrode of the driving transistor, and that diode-couple the driving transistor in response to the threshold voltage compensation signal, a first capacitor coupled between the first electrode of the driving transistor and the gate electrode of the driving transistor, a second capacitor coupled between the first capacitor and the gate electrode of the driving transistor, and a third transistor coupled between the second electrode of the driving transistor and the organic light emitting diode, that periodically turns on and off in response to the light emitting control signal.

In exemplary embodiments, the driving transistor and the first through third transistors may be p-channel metal oxide semiconductor (PMOS) transistors.

In exemplary embodiments, organic light emitting diodes may emit light simultaneously in response to the light emitting control signal that is simultaneously supplied to the pixels. Here, each of the organic light emitting diodes may be included in each of the pixels.

In exemplary embodiments, threshold voltages of driving transistors may be simultaneously compensated based on the threshold voltage compensation signal that is simultaneously supplied to the pixels. Here, each of the driving transistors may be included in each of the pixels.

In exemplary embodiments, the data signal and a reference signal may be alternately applied to the pixels through the data-line. Here, the reference signal may initialize the first capacitor.

In exemplary embodiments, a panel-load of the display panel and power consumption may decrease as the first power source voltage and the second power source voltage are supplied as direct-current (DC) power source voltages.

In exemplary embodiments, the organic light emitting display device may further include a timing controller that controls the scan driving unit, the data driving unit, the compensation control unit and the light emitting control unit.

According to some exemplary embodiments, a method of driving an organic light emitting display device may include a step of initializing a storage capacitor by simultaneously applying a reference signal to a plurality of pixels through a plurality of data-lines, each of the pixels having a p-channel metal oxide semiconductor (PMOS) transistor, a step of diode-coupling a driving transistor by simultaneously applying a threshold voltage compensation signal having a logic low level to the pixels, a step of sequentially applying a scan signal having a logic low level to the pixels through a plurality of scan-lines, a step of applying a data signal to the pixels through the data-lines based on the scan signal, a step of simultaneously applying a light emitting control signal having a logic low level to the pixels after the scan signal is sequentially applied to all of the pixels, and a step of applying a first power source voltage as a direct-current (DC) power source voltage to organic light emitting diodes based on the light emitting control signal, each of the organic light emitting diodes being in each of the pixels.

In exemplary embodiments, a data voltage of a previous frame stored in the storage capacitor may be changed into a reference voltage corresponding to the reference signal, and a voltage of a gate electrode of the driving transistor may be changed into a voltage corresponding to a difference between the first power source voltage and a threshold voltage of the driving transistor when the storage capacitor is initialized.

In exemplary embodiments, a leaked part may be recharged and compensated by applying a voltage corresponding to a difference between the first power source voltage and the threshold voltage of the driving transistor to the gate electrode of the driving transistor when the driving transistor is diode-coupled.

In exemplary embodiments, the reference voltage stored in the storage capacitor may be changed into a data voltage corresponding to a data signal, and the voltage of the gate electrode of the driving transistor may be reduced by a difference between the reference voltage and the data voltage by a capacitor coupling when the data signal is applied to the pixels.

In exemplary embodiments, organic light emitting diodes may simultaneously emit light based on the light emitting control signal. Here, each of the organic light emitting diodes may be included in each of the pixels.

Therefore, an organic light emitting display device according to an exemplary embodiment may perform a simultaneous emission with active voltage (SEAV) operation using a DC power source voltage. Thus, the organic light emitting display device may be implemented by a simple circuit structure, and may consume a small amount of power because the organic light emitting display device does not include a driving circuit for changing a power source voltage.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a circuit diagram illustrating a pixel circuit according to an exemplary embodiment;

FIG. 2 is a timing diagram illustrating a method of driving an organic light emitting display device of FIG. 1;

FIGS. 3A through 3F are diagrams illustrating a method of driving an organic light emitting display device of FIG. 1;

FIG. 4 is a flow chart illustrating a method of driving an organic light emitting display device according to the exemplary embodiment;

FIG. 5 is a diagram illustrating a display panel having a pixel circuit of FIG. 1;

FIG. 6 is a block diagram illustrating an organic light emitting display device according to the exemplary embodiment; and

FIG. 7 is a block diagram illustrating an electric device having an organic light emitting display device of FIG. 6.

### DETAILED DESCRIPTION OF THE INVENTION

Various exemplary embodiments will be described more fully hereinafter with reference to the accompanying drawings, in which some exemplary embodiments are shown.

The present inventive concept may, however, be embodied in many different forms and should not be construed as limited to the exemplary embodiments set forth herein. Rather, these exemplary embodiments are provided so that this disclosure will be thorough and complete, and will fully convey the scope of the present inventive concept to those skilled in the art. In the drawings, the sizes and relative sizes of layers and regions may be exaggerated for clarity. Like numerals refer to like elements throughout.

It will be understood that, although the terms first, second, third, etc., may be used herein to describe various elements, these elements should not be limited by these terms. These terms are used to distinguish one element from another. Thus, a first element discussed below could be termed a second element without departing from the teachings of the present inventive concept. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular exemplary embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

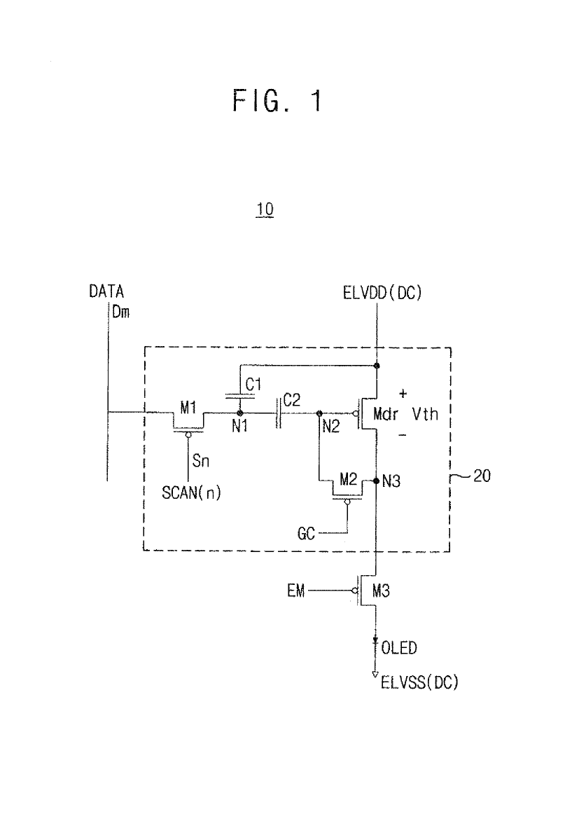

FIG. 1 is a circuit diagram illustrating a pixel circuit according to an exemplary embodiment.

Referring to FIG. 1, a pixel circuit 10 includes a pixel unit 20 coupled to an organic light emitting diode OLED and a light emitting control transistor M3. The light emitting control transistor M3 is coupled between the pixel unit 20 and the organic light emitting diode OLED. The pixel unit 20 is coupled to the crossing point of a data-line Dm and a scan-line Sn, and receives the first power source voltage ELVDD and the second voltage ELVSS that are direct-current (DC) power source voltages.

The pixel unit 20 may include a driving transistor Mdr, a transistor M1, a transistor M2, a capacitor C1, and a capacitor C2. The driving transistor Mdr may include a first electrode that receives the first power source voltage ELVDD and a second electrode that is coupled at node N3 to the organic light emitting diode OLED. The transistor M1 may be coupled between a data-line Dm and, via node N1, capacitor C2 and node N2, the gate electrode of the driving transistor Mdr, and may supply a data signal DATA to the gate electrode of the driving transistor Mdr in response to a scan signal SCAN(n). The transistor M2 may be coupled between the second electrode of the driving transistor Mdr at node N3 and the gate electrode of the driving transistor Mdr at node N2. The capacitor C1 may be coupled between the first electrode of the driving transistor Mdr and the gate electrode of the driving transistor Mdr at node N1. The capacitor C2 may be coupled between the capacitor C1 at node N1 and the gate electrode of the driving transistor Mdr.

The light emitting control transistor M3 is periodically turned on-off in response to a light emitting control signal EM having a logic high level and a logic low level in a frame. Namely, the power source voltages ELVDD and ELVSS are periodically coupled with the organic light emitting diode OLED based on open and close operations of the light emitting control transistor M3. Accordingly, the pixel circuit 10 may have the same effect as other pixel circuits that periodically change the power source voltages ELVDD and ELVSS. In other words, the pixel circuit 10 may periodically change the power source voltages ELVDD and ELVSS by controlling DC power source voltages (i.e., the power source voltages ELVDD and ELVSS) using the light emitting control transistor M3 without swinging the power source voltages ELVDD and ELVSS using an extra driving circuit.

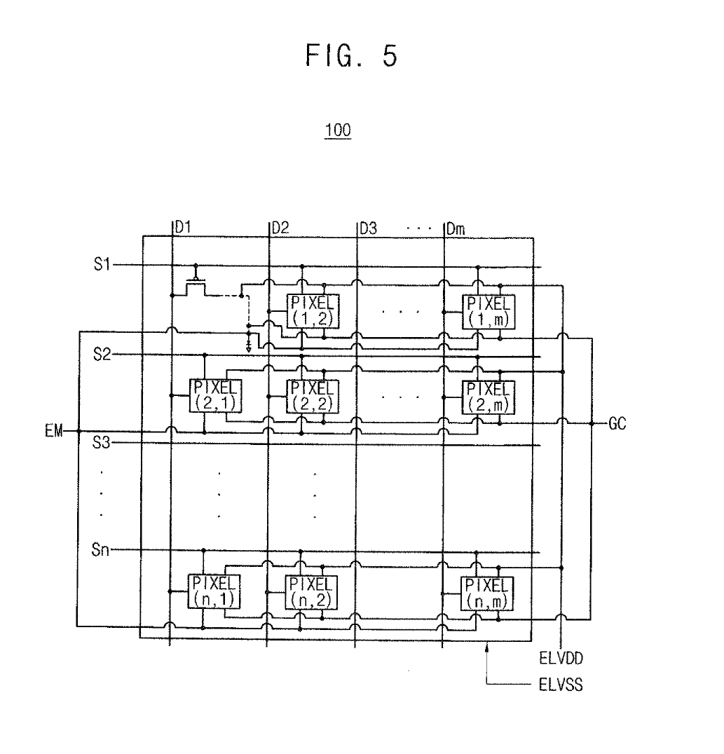

The light emitting control signal EM is simultaneously provided to a plurality of light emitting control transistors M3 included in a display panel (see FIG. 5). Accordingly, the organic light emitting diode OLED that is coupled to each of the light emitting control transistors M3 may simultaneously emit light. In detail, organic light emitting diodes OLED included in the display panel may simultaneously emit light when the light emitting signals EM are simultaneously applied to the pixel circuits 10 after scan signals SCAN(n) are sequentially applied to the pixel circuits 10 in a frame. Therefore, simultaneous emission with active voltage (SEAV) operation is performed using DC power source voltages (i.e., the power source voltages ELVDD and ELVSS), so that power consumption may be reduced.

The pixel circuit 10 may be implemented by p-channel metal oxide semiconductor (PMOS) transistors. That is, the driving transistor Mdr, the transistor M1, the transistor M2, and the light emitting control transistor M3 may be PMOS transistors. Accordingly, the transistors (i.e., the driving transistor Mdr, the transistor M1, the transistor M2, and the light emitting control transistor M3) may turn on when signals having a logic low level are applied to gate electrodes of the transistors. On the other hand, the transistors may turn off when signals having a logic high level are applied to gate electrodes of the transistors.

A reference voltage corresponding to the reference signal and a data voltage corresponding to the data signal DATA may be alternately stored in the capacitor C1 when the reference signal and the data signal DATA are alternately applied through a data-line Dm. When the reference signal is applied, a data voltage of a previous frame that is stored in the capacitor C1 may be changed into the reference voltage corresponding to the reference signal, and a voltage of the gate electrode of the driving transistor Mdr may be changed into a voltage corresponding to a difference between the first power source voltage ELVDD and a threshold voltage Vth of the driving transistor Mdr. In detail, during a previous frame, a voltage of the gate electrode of the driving transistor Mdr has a data voltage component of the previous frame. During a current frame, a voltage of the gate electrode of the driving transistor Mdr may be changed into a voltage corresponding to a difference between the first power source voltage ELVDD and a threshold voltage Vth of the driving transistor Mdr by a coupling of the capacitor C2 when the reference signal is applied. Therefore, a threshold voltage Vth of the driving transistor Mdr may be compensated (e.g., referred to as the first compensation).

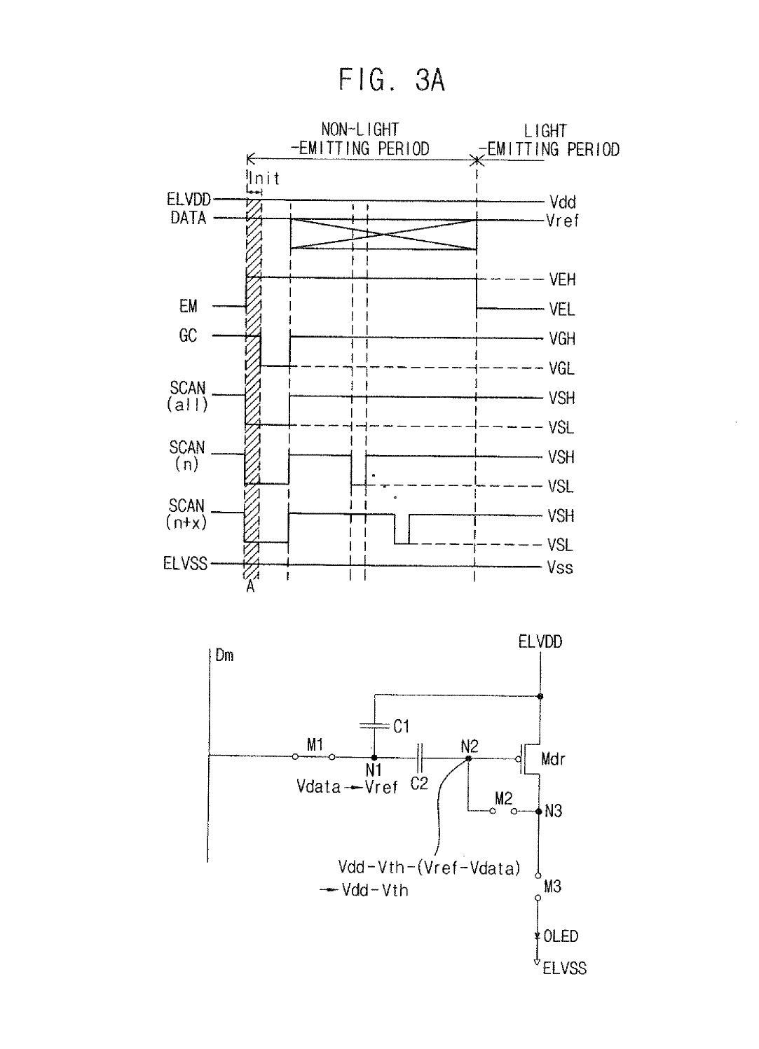

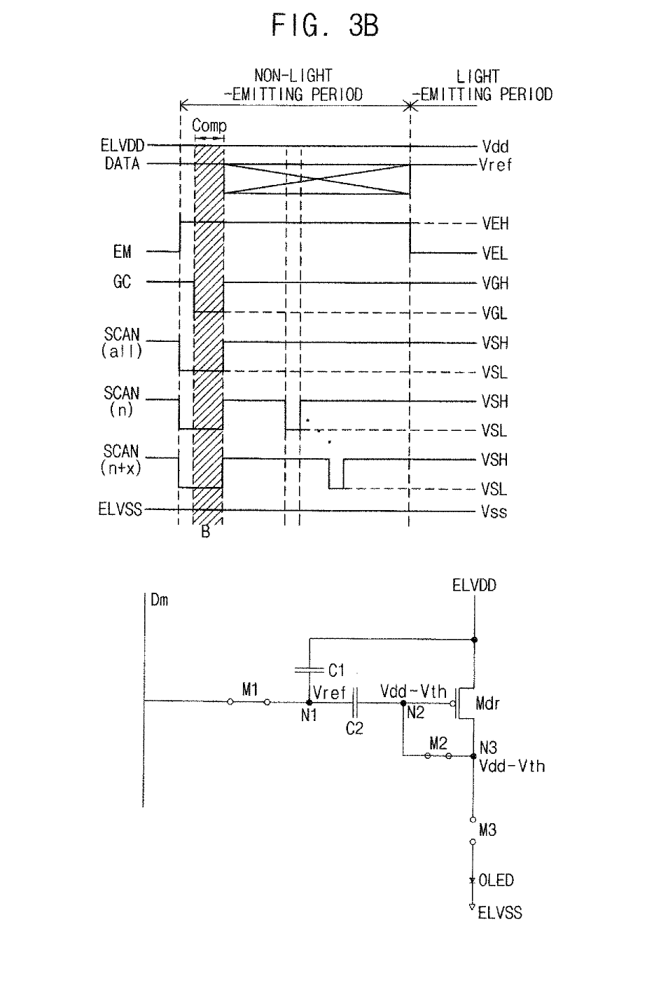

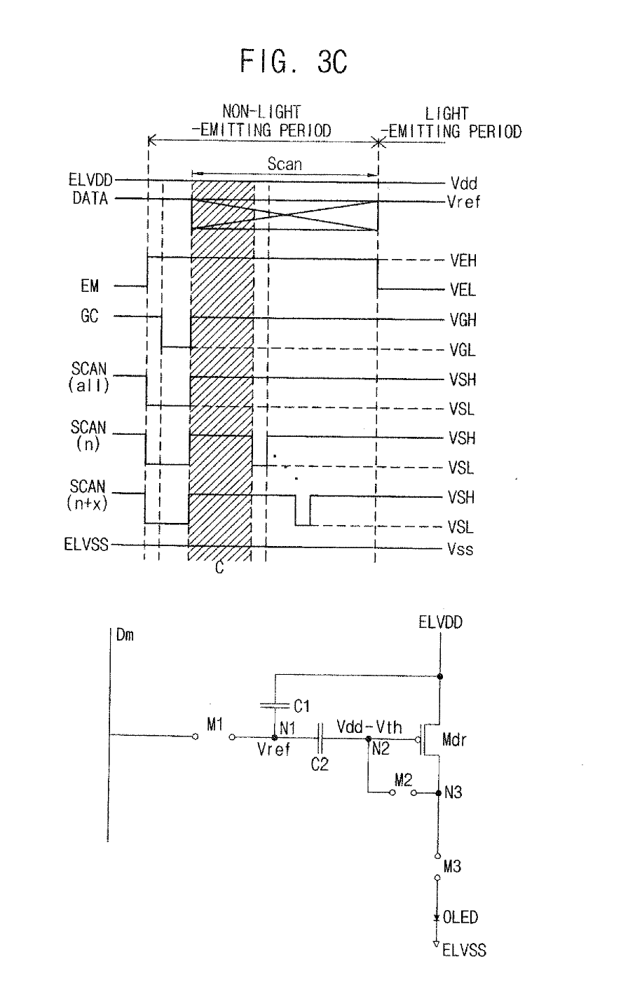

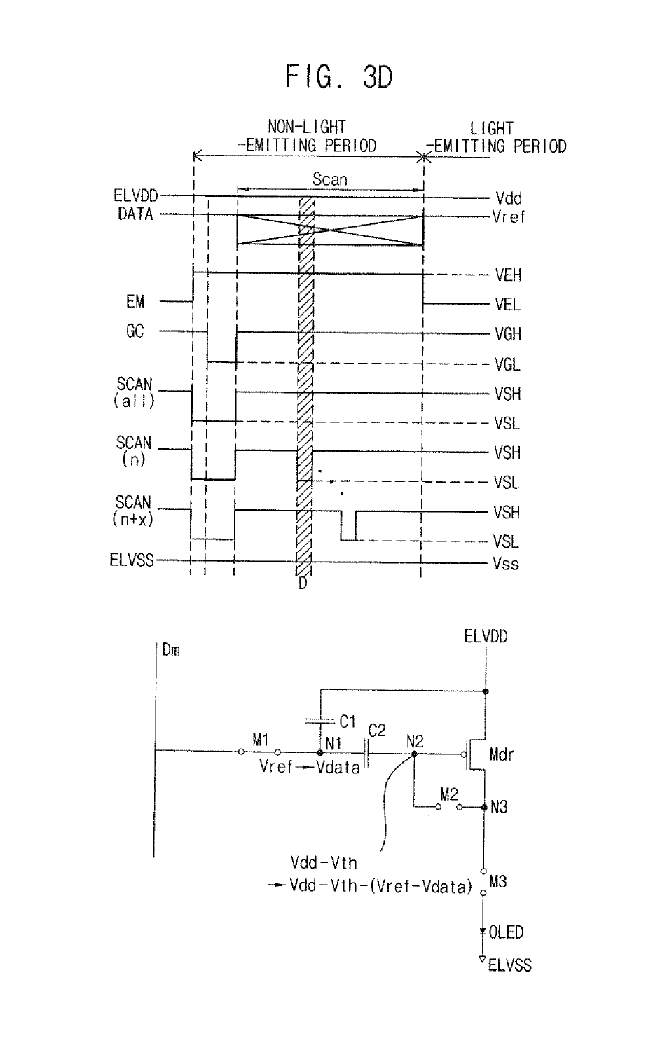

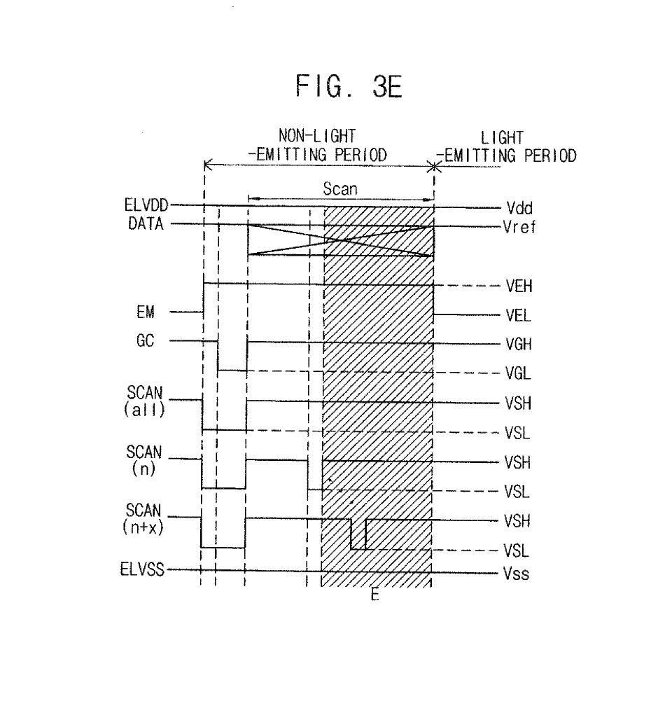

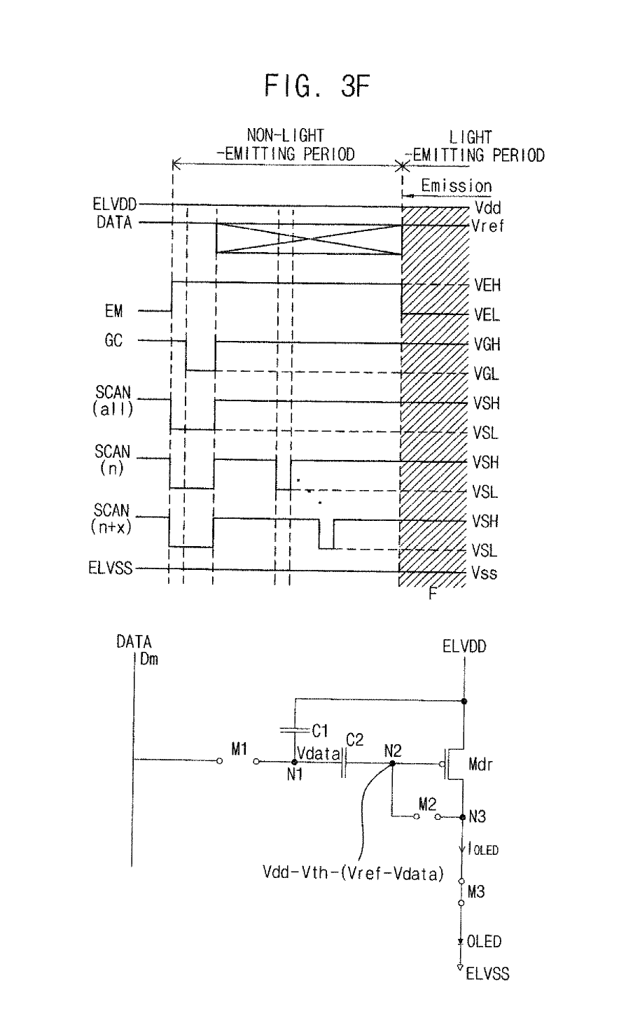

The transistor M2 may be diode-couple the driving transistor Mdr in response to a threshold voltage compensation signal GC. At this time, a voltage corresponding to a difference between the first power source voltage ELVDD and a threshold voltage Vth of the driving transistor Mdr may be applied to the gate electrode of the driving transistor Mdr. Thus, a part leaked from a voltage of the gate electrode of the driving transistor Mdr (i.e., a voltage corresponding to a difference between the first power source voltage ELVDD and a threshold voltage Vth of the driving transistor Mdr) may be recharged and compensated. Accordingly, a threshold voltage Vth of the driving transistor Mdr may be compensated (e.g., referred to as the second compensation). Furthermore, the threshold voltages Vth of the driving transistors Mdr included in a plurality of pixel circuits 10 may be simultaneously compensated based on the threshold voltage compensation signal GC that is simultaneously provided to the pixel circuits 10. A compensation for a threshold voltage Vth of the driving transistor Mdr will be described in more detail later with reference to FIGS. 3A through 3F.

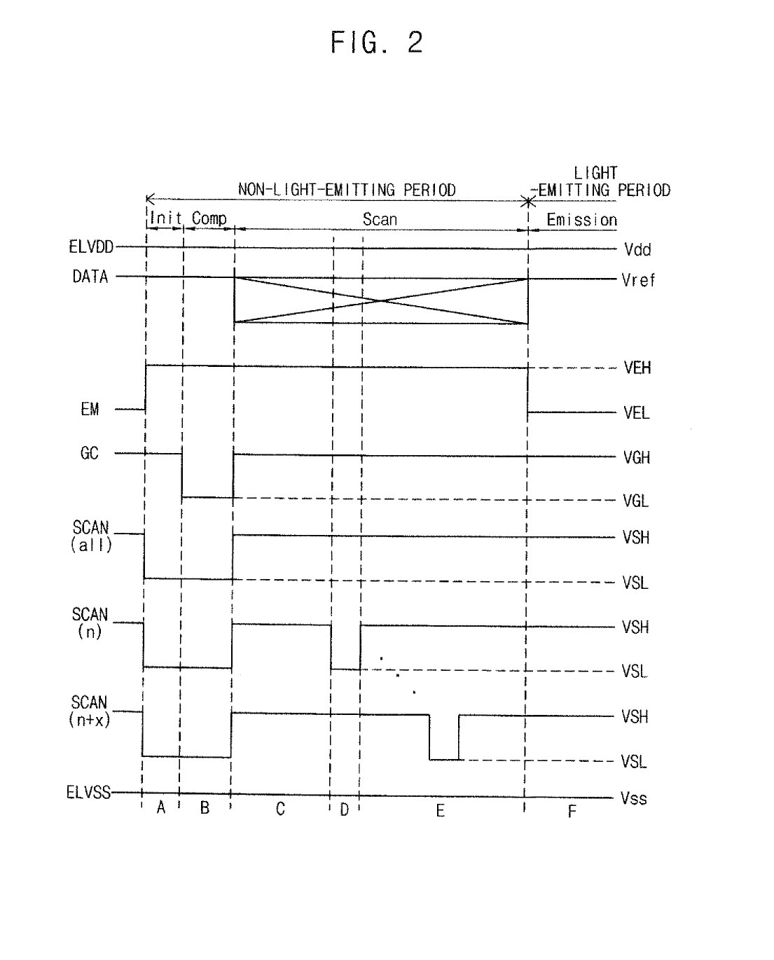

FIG. 2 is a timing diagram illustrating a method of driving an organic light emitting display device of FIG. 1.

Referring to FIG. 2, one frame for driving an organic light emitting display device may include periods A through F. Namely, one frame may be divided into a non-light-emitting period and a light-emitting period, the non-light-emitting period may include an initialization period A (i.e., Init), a compensation period B (i.e., Comp), scan periods C through E (i.e., Scan), and the light-emitting period may include the light emitting period F (i.e., Emission).

As described above, since the first power source voltage ELVDD and the second power source voltage ELVSS are direct-current (DC) power source voltages, the first power source voltage ELVDD may have a constant value Vdd, and the second power source voltage ELVSS may have a constant value Vss. A data signal DATA may have a voltage level of a reference voltage Vref. Various data voltage (i.e., a portion indicating X) corresponding to the data signal DATA may be provided to each of the pixels in scan periods Scan. The light emitting control signal EM, the threshold voltage compensation signal GC, and the scan signal SCAN(n) may have a voltage having a logic high level and a logic low level, respectively. As described above, transistors that receive a voltage having a logic low level (e.g., VEL or VGL) may turn on when the voltage is applied to the transistors because the transistors are implemented by PMOS transistors. On the other hand, transistors that receive a voltage having a logic high level (e.g., VEH or VGH) may turn off when the voltage is applied to the transistors because the transistors are implemented by PMOS transistors. Here, a voltage having a logic high level and a voltage having a logic low level may be set as various values based on required conditions for a product having an organic light emitting display device.

FIGS. 3A through 3F are diagrams illustrating a method of driving an organic light emitting display device of FIG. 1. Hereinafter, referring to FIGS. 3A through 3F, the method will be described in detail.

Referring to FIG. 3A, the first period A may correspond to an initialization phase Init. In the first period A, scan signals SCAN may be simultaneously applied to all scan-lines. In other words, a scan voltage VSL having a logic low level may be applied to all scan-lines. Thus, the transistor M1 turns on, and the reference voltage Vref is applied to the node N1 through a data-line Dm. As a result, a voltage of a capacitor C1 may be changed from a data voltage Vdata of a previous frame to a reference voltage Vref. That is, information of a previous frame (i.e., a data voltage of a previous frame) may be initialized. A voltage of the node N2 is changed from a voltage of a previous frame to a voltage of a current frame by a coupling of the capacitor C2 when a voltage of the node N1 is changed from the data voltage Vdata to the reference voltage Vref. In other words, a component of the data voltage Vdata of a previous frame and a component of the reference voltage Vref of a previous frame may be removed from a voltage consisting of a voltage corresponding to a difference between the first power source voltage Vdd and a threshold voltage Vth of the driving transistor Mdr, and components of the data voltage Vdata and the reference voltage Vref of a previous frame. This is expressed as Equation 1.

VN2=Vdd−Vth−(Vref−Vdata)Vdd−Vth Equation 1
(Here, VN2 denotes a voltage of the node N2)

The transistor M2 and the transistor M3 are in off-state because a threshold voltage compensation signal GC and a light emitting control signal EM are applied as a voltage having a logic high level.

Referring to FIG. 3B, the second period B may correspond to a compensation interval Comp. In the second period B, a threshold voltage compensation signal VGL having a logic low level is applied to the transistor M2. Thus, the driving transistor Mdr may be diode-coupled because the transistor M2 turns on. At this time, a voltage leaked from a voltage of the node N2 set at the first period A (i.e., a voltage corresponding to a difference between the first power source voltage Vdd and a threshold voltage Vth of the driving transistor Mdr) may be recharged and compensated because a voltage corresponding to a difference between the first power source voltage Vdd and a threshold voltage Vth of the driving transistor Mdr is applied to the node N2. As a result, a component of a threshold voltage Vth of the driving transistor Mdr is applied to the gate electrode of the driving transistor Mdr in the first period A, and a component of a threshold voltage Vth of the driving transistor Mdr is applied to the gate electrode of the driving transistor Mdr in the second period B. Thus, a threshold voltage Vth of the driving transistor Mdr may be effectively compensated. In addition, each threshold voltage Vth of the driving transistors Mdr included in a plurality of pixel circuits 10 may be simultaneously compensated based on the threshold voltage compensation signal GC that is simultaneously provided to the pixel circuits 10. The transistor M3 is in off-state because the light emitting control signal EM is applied as a logic high level.

Referring to FIG. 3C, the third period C may correspond to a scan period Scan. In the third period C, a data signal DATA corresponding to an image which each of the pixel circuits 10 displays may be applied to each of the pixel circuits 10 through a data-line Dm. A pixel circuit 10 that is not scanned is shown in FIG. 3C. Here, a scan signal SCAN having a logic high level VSH is applied, so that the transistor M1 may turn off. In addition, the transistor M2 may turn off because a threshold voltage compensation signal GC having a logic high level is applied to the transistor M2. Accordingly, the node N1 is maintained as the reference voltage Vref, and the node N2 is maintained as a voltage corresponding to a difference between the first power source voltage Vdd and a threshold voltage Vth of the driving transistor Mdr because a voltage stored in the capacitor C2 is maintained.

Referring to FIG. 3D, the fourth period D may correspond to a scan period Scan. A scan signal SCAN(n) is applied to the transistor M1 of the n(th) pixel circuit, so that a data signal DATA may be input through the data-line Dm in the fourth period D. Accordingly, a data signal DATA corresponding to an image which the n(th) pixel circuit displays may be stored in the capacitor C1. In other words, a voltage of the node N1 is changed from a reference voltage Vref to a data voltage Vdata. As a result, a voltage of the node N2 may be changed by a variation of a voltage of the node N1 by a coupling of the capacitor C2. This is expressed as Equation 2 and Equation 3.

V_{N1}=Vref→Vdata Equation 2
(Here, V_{N1} denotes a voltage of the node N1)

V_{N2}=Vdd−Vth→Vdd−Vth−(Vref−Vdata) Equation 3
(Here, V_{N2} denotes a voltage of the node N2)

Since the threshold voltage compensation signal GC and the light emitting control signal EM having a logic high level are applied, the transistor M2 and the transistor M3 may be in off-state.

Referring to FIG. 3E, the fifth period E may correspond to the scan period Scan. For all pixel circuits included in a display panel, data scanning is sequentially (i.e., by the line) performed. Namely, the data scanning is performed for the pixel circuits as described referring to FIG. 3D. Data scanning is completed in the fifth period E before a plurality of organic emitting light diodes simultaneously emit light in the sixth period F. That is, the periods A through E correspond to non light emitting periods.

Referring to FIG. 3F, the sixth period F may correspond to an emission period Emission. In the sixth period F, a light emitting control signal VEL having a logic low level is applied to the transistor M3. Then, the transistor M3 turns on, so that an organic light emitting diode current I_{OLED} may flow through the organic light emitting diode OLED. Thus, the organic light emitting diode OLED may emit light. Here, the organic light emitting diode current I_{OLED} includes a voltage component that is set at the node N2. As described above, in the scan period Scan, the organic light emitting diode current I_{OLED} has a value generated by eliminating a component corresponding to a threshold voltage Vth of the driving transistor Mdr because the voltage that is set at the node N2 includes the component corresponding to a threshold voltage Vth of the driving transistor Mdr. This is expressed as Equation 4 through Equation 7.

Vs=Vdd Equation 4
(Here, Vs denotes a voltage of the source electrode of the driving transistor Mdr)

Vg=Vdd−Vth−(Vref−Vdata) Equation 5
(Here, Vg denotes a voltage of the gate electrode of the driving transistor Mdr)

Vsg=Vdd−{Vdd−Vth−(Vref−Vdata)}=Vref−Vdata+Vth Equation 6

I_{OLED}=½*k*(Vsg−Vth)²=½*k*(Vref−Vdata)² Equation 7
(Here, k denotes a constant according to the driving transistor Mdr)

As shown in Equation 7, a component corresponding to the threshold voltage Vth of the driving transistor Mdr is removed. Hence, the organic light emitting diode OLED may allow the organic light emitting diode current I_{OLED} that is irrelevant to a threshold voltage Vth of the driving transistor Mdr to flow. As a result, deviations among pixel circuits may be eliminated.

In addition, it is determined whether a saturation condition according to a magnitude of a data voltage Vdata is met or not as shown in Equation 8 below.
(1) In case of Vdata=Vref,

Vsd=Vdd>Vsg−Vth=Vth−Vth=0, the saturation condition is met.
(2) In case of Vdata=0,

Vsd=Vdd>Vsg−Vth=Vref, the saturation condition is met. Equation 8
(Here, Vsd denotes a voltage between a source electrode and a drain electrode of the driving transistor Mdr)

A light emitting control signal EM may be simultaneously provided to a plurality of pixel circuits. Thus, an organic light emitting diode OLED in each pixel circuit may simultaneously emit light. Hence, a simultaneous emission with active voltage (SEAV) operation may be performed using direct-current (DC) power source voltages. The transistors M1 and M2 are in turn-off state because a scan signal SCAN having a logic high level and a threshold voltage compensation signal GC having a logic high level are applied to the transistors M1 and M2, respectively.

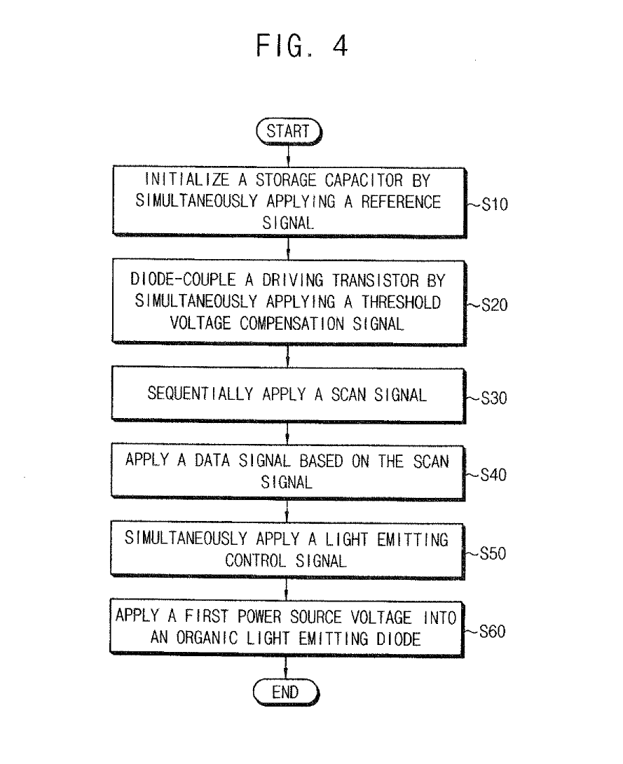

FIG. 4 is a flow chart illustrating a method of driving an organic light emitting display device according to the exemplary embodiment.

Referring to FIG. 4, a storage capacitor is initialized by simultaneously applying a reference signal to a plurality of pixels through a plurality of data-lines (Step S10). The pixels may include PMOS transistors. Then, a driving transistor is diode-coupled by simultaneously applying a threshold voltage compensation signal having a logic low level (Step S20). A scan signal having a logic low level is sequentially applied to the pixels through a plurality of scan-lines (Step S30), and a data signal is applied to the pixels through the data-lines based on the scan signal (Step S40). A light emitting control signal having a logic low level is simultaneously applied to the pixels after the scan signal is sequentially applied to all pixels (Step S50). Then, a first power source voltage that is DC power source voltage is applied to organic light emitting diodes included in the pixels based on a light emitting control signal (Step S60). As a result, the organic light emitting diodes simultaneously emit light. Based on the method of FIG. 4, a simultaneous emission with active voltage (SEAV) operation may be performed using the DC power source voltage. Duplicated descriptions will be omitted.

FIG. 5 is a diagram illustrating a display panel having a pixel circuit of FIG. 1.

Referring to FIG. 5, a display panel 100 may include a plurality of pixels PIXEL. The pixels PIXEL are coupled to crossing points of a plurality of data-lines D1 through Dm and a plurality of scan-lines 51 through Sn. That is, the pixels PIXEL are arranged in a matrix form. Each of the pixels PIXEL may sequentially receive scan signals through the scan-lines 51 through Sn. For instance, the scan signals may be sequentially input from a scan-line 51 to a scan-line Sn. Based on the scan signals, data signals corresponding to an image may be input to the pixels PIXEL through the data-lines D1 through Dm.

Power source voltages ELVDD and ELVSS that are DC power source voltages may be provided to the pixels PIXEL in a display panel 100. Hence, extra driving circuits (e.g., a power switching circuit, etc) for periodically changing power source voltages may be unnecessary, and power consumption may be reduced as panel loads decrease.

A light emitting control signal EM and a threshold voltage compensation signal GC may be simultaneously provided to each of the pixels PIXEL. Thus, the pixels PIXEL in the display panel 100 may be simultaneously compensated. In addition, the pixels PIXEL in the display panel 100 may simultaneously emit light.

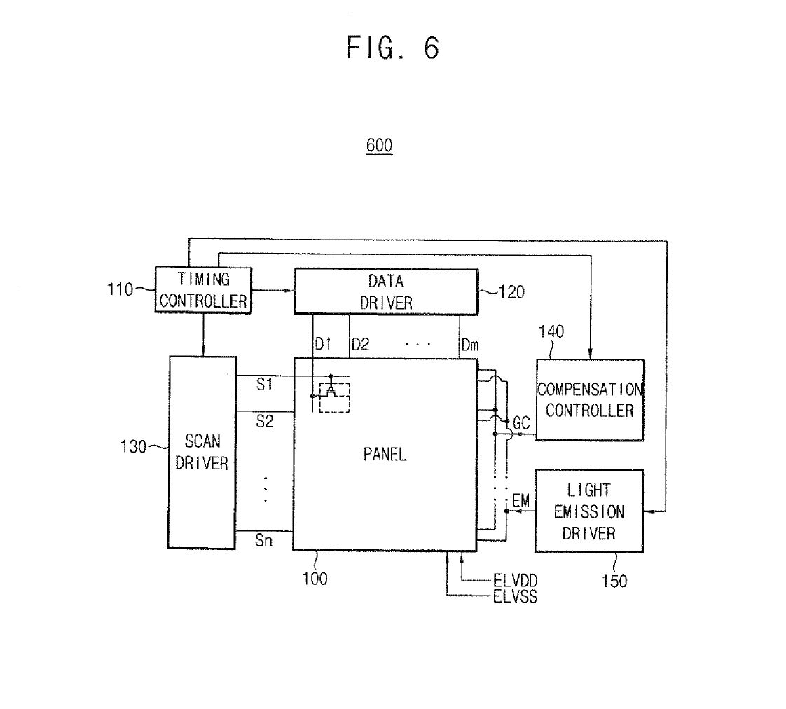

FIG. 6 is a block diagram illustrating an organic light emitting display device according to the exemplary embodiment.

Referring to FIG. 6, an organic light emitting display device 600 may include a display panel 100, a timing controller 110, a data driver 120, a scan driver 130, a compensation controller 140 and a light emission driver 150.

The display panel 100 may include a plurality of pixels, and may receive a first power source voltage ELVDD and a second power source voltage ELVSS that are direct-current (DC) power source voltages. Each of the pixels may include an organic light emitting diode, a driving transistor, a transistor that receives a scan signal, a transistor that receives a threshold voltage compensation signal GC, and a transistor that receives a light emitting control signal EM. Each of the transistors may be PMOS transistors.

The scan driver 130 may sequentially provide scan signals to the pixels through a plurality of scan-lines S1 through Sn. The data driver 120 may provide data signals to the pixels through a plurality of data-lines D1 through Dm based on the scan signals. The compensation controller 140 may simultaneously provide the threshold voltage compensation signal GC to the pixels. The light emission driver 150 may simultaneously provide the light emitting control signal EM to the pixels. The timing controller 110 may control the scan driver 130, the data driver 120, the compensation controller 140, and the light emission driver 150.

The threshold voltage compensation signal GC and light emitting control signal EM may be simultaneously provided to the pixels. Thus, the pixels may be simultaneously compensated. In addition, the pixels may simultaneously emit light.

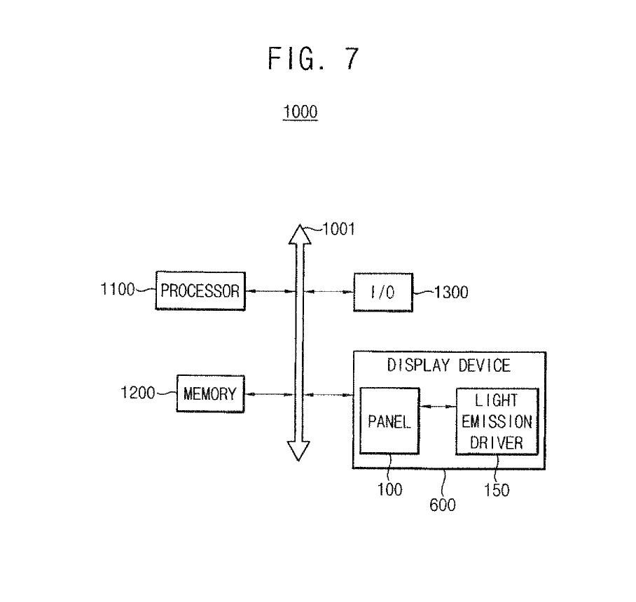

FIG. 7 is a block diagram illustrating an electric device having an organic light emitting display device of FIG. 6.

Referring to FIG. 7, the electric device 1000 may include a processor 1100, a memory device 1200, an Input-Output (I/O) device 1300, and the light emitting display device 600.

The processor 1100 may perform various computing functions. For instance, the processor 1100 may be a micro-processor or a Central Processing Unit (CPU). The processor 1100 may be coupled to the memory device 1200 through a bus 1001. The processor 1100 may be coupled to the memory device 1200 and the light emitting display device 600 through an address bus, a control bus, and a data bus. The processor 1100 may be coupled to an extension bus such as a Peripheral Component Interconnects (PCI) bus.

The memory device 1200 may include a volatile memory device such as a Dynamic Random Access Memory (DRAM) device, a Static Random Access Memory (SRAM) device, etc, and a non-volatile memory device such as an Erasable Programmable Read-Only Memory (EPROM) device, an Electrically Erasable Programmable Read-Only Memory (EEPROM) device, and a flash memory device, etc. The memory device 1200 may store the software that is performed by the processor 1100.

The I/O device 1300 may be coupled to the bus 1001, and may include input means such as a keyboard, a mouse, etc, and output means such as a printer. The processor 1100 may control operations of the I/O device 1300.

The light emitting display device 600 may be coupled to the processor 1001 through the bus 1001. The light emitting display device 600 may include a display panel 100 and a light emission driver 150. As described above, a plurality of pixels in the display panel 100 may be provided with DC power source voltage, and may be simultaneously provided with a threshold voltage compensation signal. Thus, the pixels in the display panel 100 may be simultaneously compensated. In addition, the pixels may simultaneously emit light by simultaneously receiving a light emitting control signal from the light emission driver 150.

As a result, the light emitting display device 600 may perform a simultaneous emission with active voltage (SEAV) operation using a direct-current (DC) power source voltage.

The electric device 1000 may correspond to an electric device having at least one display device such as a cellular phone, a smart phone, a smart pad, a television, a Personal Digital Assistant (PDA), a MP3 player, a laptop computer, a desk top computer, a digital camera, etc.

The present inventive concept may be widely applied to an electric device having at least one display device. For example, the present inventive concept may be applied to a computer monitor, a laptop computer, a personal digital assistant PDA, a smart phone, a smart pad, a medium-large size display panel, etc.

The foregoing is illustrative of exemplary embodiments and is not to be construed as limiting thereof. Although a few exemplary embodiments have been described, those skilled in the art will readily appreciate that many modifications are possible in the exemplary embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various exemplary embodiments and is not to be construed as limited to the specific exemplary embodiments disclosed, and that modifications to the disclosed exemplary embodiments, as well as other exemplary embodiments, are intended to be included within the scope of the appended claims.

What is claimed is:

1. A pixel circuit comprising:
a pixel unit coupled to a crossing point of a data-line and a scan-line, and configured to receive a first power source voltage and a second power source voltage, the first and second power source voltages being direct-current (DC) power source voltages;
an organic light emitting diode coupled to the pixel unit; and
a light emitting control transistor coupled between the pixel unit and the organic light emitting diode, the light emitting control transistor periodically turning on and off in response to a light emitting control signal having a logic high level and a logic low level in a frame, the light emitting control signal being simultaneously provided to a plurality of said light emitting control transistors in a display panel.

2. The pixel circuit as set forth in claim 1, the pixel unit including:
a driving transistor having a first electrode that receives the first power source voltage and a second electrode that is coupled to the organic light emitting diode;
a first transistor coupled between the data-line and a gate electrode of the driving transistor, and configured to supply a data signal to the gate electrode of the driving transistor in response to a scan signal;
a second transistor coupled between the second electrode of the driving transistor and the gate electrode of the driving transistor;
a first capacitor coupled between the first electrode of the driving transistor and the gate electrode of the driving transistor; and
a second capacitor coupled between the first capacitor and the gate electrode of the driving transistor.

3. The pixel circuit as set forth in claim 2, the light emitting control transistor, the driving transistor, the first transistor, the second transistor and the light emitting control transistor being p-channel metal oxide semiconductor (PMOS) transistors.

4. The pixel circuit as set forth in claim 3, the second transistor applying a threshold voltage of the driving transistor to the second capacitor by diode-coupling the driving transistor in response to a threshold voltage compensation signal.

5. The pixel circuit as set forth in claim 4, the light emitting control transistor being coupled between the second electrode of the driving transistor and the organic light emitting diode.

6. The pixel circuit as set forth in claim 5, the light emitting control transistor periodically coupling the first power source voltage to the organic light emitting diode in response to the light emitting control signal.

7. The pixel circuit as set forth in claim 6, a reference voltage and a data voltage being alternately stored in the first capacitor as a reference signal and the data signal being alternately applied through the data-line, the reference voltage corresponding to the reference signal, and the data voltage corresponding to the data signal.

8. The pixel circuit as set forth in claim 7, a data voltage of a previous frame stored in the first capacitor being changed into the reference voltage, and a voltage of the gate electrode of the driving transistor being changed into a voltage corresponding to a difference between the first power source voltage and the threshold voltage of the driving transistor when the reference signal is applied.

9. An organic light emitting display device comprising:
a display panel having a plurality of pixels configured to receive a first power source voltage and a second power source voltage that are direct-current (DC) power source voltages;
a scan driving unit configured to sequentially supply a scan signal to the pixels through a plurality of scan-lines;
a data driving unit configured to supply a data signal to the pixels through a plurality of data-lines based on the scan signal;
a compensation control unit configured to simultaneously supply a threshold voltage compensation signal to the pixels; and
a light emitting control unit configured to simultaneously supply a light emitting control signal to the pixels, each of the pixels including:
an organic light emitting diode;
a driving transistor having a first electrode that receives the first power source voltage and a second electrode that is coupled to the organic light emitting diode;
a first transistor coupled between the data-line and the gate electrode of the driving transistor, and configured to supply the data signal to the gate electrode of the driving transistor in response to the scan signal;
a second transistor coupled between the second electrode of the driving transistor and the gate electrode of the driving transistor, and configured to diode-couple the driving transistor in response to the threshold voltage compensation signal;
a first capacitor coupled between the first electrode of the driving transistor and the gate electrode of the driving transistor;
a second capacitor coupled between the first capacitor and the gate electrode of the driving transistor; and
a third transistor coupled between the second electrode of the driving transistor and the organic light emitting diode, and configured to periodically turn on and off in response to the light emitting control signal.

10. The organic light emitting display device as set forth in claim 9, the driving transistor and the first through third transistors being p-channel metal oxide semiconductor (PMOS) transistors.

11. The organic light emitting display device as set forth in claim 10, the organic light emitting diodes emitting light simultaneously in response to the light emitting control signal that is simultaneously supplied to the pixels, each of the organic light emitting diodes being included in each of the pixels.

12. The organic light emitting display device as set forth in claim 11, threshold voltages of driving transistors being simultaneously compensated based on the threshold voltage compensation signal that is simultaneously supplied to the pixels, each of the driving transistors being included in each of the pixels.

13. The organic light emitting display device as set forth in claim 12, the data signal and a reference signal being alternately applied to the pixels through the data-line, the reference signal initializing the first capacitor.

14. The organic light emitting display device as set forth in claim 13, a panel-load of the display panel and power consumption decreasing as the first power source voltage and the second power source voltage are supplied as direct-current (DC) power source voltages.

15. The organic light emitting display device as set forth in claim 14, further comprising:
a timing controller configured to control the scan driving unit, the data driving unit, the compensation control unit and the light emitting control unit.

16. A method of driving an organic light emitting display device, the method comprising:
initializing a storage capacitor by simultaneously applying a reference signal to a plurality of pixels through a plurality of data-lines, each of the pixels having a p-channel metal oxide semiconductor (PMOS) transistor;
diode-coupling a driving transistor by simultaneously applying a threshold voltage compensation signal having a logic low level to the pixels;
sequentially applying a scan signal having a logic low level to the pixels through a plurality of scan-lines;
applying a data signal to the pixels through the data-lines based on the scan signal;
simultaneously applying a light emitting control signal having a logic low level to the pixels after the scan signal is sequentially applied to all of the pixels; and
applying a first power source voltage as a direct-current (DC) power source voltage to organic light emitting diodes based on the light emitting control signal, each of the organic light emitting diodes being in each of the pixels.

17. The method as set forth in claim 16, a data voltage of a previous frame stored in the storage capacitor being changed into a reference voltage corresponding to the reference signal, and a voltage of a gate electrode of the driving transistor being changed into a voltage corresponding to a difference between the first power source voltage and a threshold voltage of the driving transistor when the storage capacitor is initialized.

18. The method as set forth in claim 17, a leaked voltage part being recharged and compensated by applying a voltage corresponding to a difference between the first power source voltage and the threshold voltage of the driving transistor to the gate electrode of the driving transistor when the driving transistor is diode-coupled.

19. The method as set forth in claim 18, the reference voltage stored in the storage capacitor being changed into a data voltage corresponding to a data signal and the voltage of the gate electrode of the driving transistor being reduced by a difference between the reference voltage and the data voltage by a capacitor coupling when the data signal is applied to the pixels.

20. The method as set forth in claim 19, organic light emitting diodes simultaneously emitting light based on the light emitting control signal, each of the organic light emitting diodes being included in each of the pixels.
